(19) United States
(12) Patent Application Publication
(10) Pub. No.: US 2022/0136906 A1
(43) Pub. Date: May 5, 2022

(54) Infrared Body Temperature Measurement Doll

(71) Applicant: SHENZHEN AIBOLONG TECHNOLOGY CO., LTD, Shenzhen, Guangdong (CN)

(72) Inventor: Guoping CHEN, Shenzhen, Guangdong (CN)

(21) Appl. No.: 17/280,833

(22) PCT Filed: Jun. 2, 2020
(86) PCT No.: PCT/CN2020/093950

§ 371 Date: Mar. 26, 2021

(30) Foreign Application Priority Data
Jul. 19, 2019 (CN) 201921136214.6

(51) Int. Cl. G01J 5/12; G01J 5/0806; G01J 5/04; A63H 3/00; A63H 3/28

(52) U.S. Cl. CPC G01J 5/12; G01J 5/0806; A63H 3/28; A63H 3/003; G01J 5/041

(57) ABSTRACT

An infrared body temperature measurement doll, includes a doll body and a temperature measurement circuit disposed in the doll body, wherein the temperature measurement circuit includes an infrared light filter, an infrared thermopile sensing element having a chip structure, an amplification circuit, a display module, a battery, and a power supply switch; the infrared light filter is disposed on the infrared thermopile sensing element having a chip structure; the infrared thermopile sensing element having a chip structure, the amplification circuit, and the display module are sequentially electrically connected; the battery supplies power to the infrared thermopile sensing element having a chip structure, the amplification circuit, and the display module; the infrared thermopile sensing element is disposed in an organ of the doll body in communication with the ambient; and the infrared thermopile sensing element senses a human body temperature via a hole on the organ.

### CROSS-REFERENCE TO RELATED APPLICATIONS

This Application is a national stage application of PCT/CN2020/093950. This application claims priorities from PCT Application No. PCT/CN2020/093950, filed Jun. 2, 2020, and from Chinese Patent Application No. 201921136214.6, filed Jul. 19, 2019, the contents of which are incorporated herein in the entirety by reference.

### TECHNICAL FIELD

The present invention relates to a temperature measurement device, and more particular to an infrared body temperature measurement doll mainly for measuring human body temperature.

### BACKGROUND

Doll is a derivative product from the role images of animated film and television play, a comic book and an online game, as well as a physical product of an original cartoon animal and a cartoon character image. Doll has cultural connotation, is full of a storyline, and even has a personalized and personified concept. Therefore, dolls are favored and liked by people at different ages. However, in addition to the appreciation effect, doll does not have any other functional effect. On the other hand, the appearance of a general infrared thermometer is basically designed in a gun shape or in a pen container shape, which is not applicable for young people and children who use the thermometer.

### SUMMARY OF THE INVENTION

In order to solve the above problems, the present invention provides the society with an infrared body temperature measurement doll which not only can satisfy the requirement of providing a playable doll, but also can achieve non-contact with human body, a quick temperature measurement speed, and a high temperature measurement accuracy.

The technical solution of the present invention is: provided is an infrared body temperature measurement doll, comprising a doll body and a temperature measurement circuit disposed in the doll body, wherein the temperature measurement circuit comprises an infrared light filter, an infrared thermopile sensing element having a chip structure, an amplification circuit, a display module, a battery, and a power supply switch; the infrared light filter is disposed on the infrared thermopile sensing element having a chip structure; the infrared thermopile sensing element having a chip structure, the amplification circuit, and the display module are sequentially electrically connected; the battery supplies power to the infrared thermopile sensing element having a chip structure, the amplification circuit, and the display module; the infrared thermopile sensing element is disposed in an organ of the doll body in communication with the ambient; and the infrared thermopile sensing element senses a human body temperature via a hole on the organ.

As an improvement of the present invention, a button hole is disposed on the doll body; and a button of the power supply switch protrudes out of the doll body via the button hole.

As an improvement of the present invention, the image of the doll body is a rat, an ox, a tiger, a hare, a dragon, a snake, a horse, a sheep, a monkey, a rooster, a dog, a boar, a rabbit, a cat, a weasel, a tapir, a dolphin, a seal, a sea lion or an anteater.

As an improvement of the present invention, the image of the doll body is a robot or an animated character.

As an improvement of the present invention, the doll body is made into a key ring or a hanging ornament.

As an improvement of the present invention, the doll body is provided with an opening corresponding to the display module; and the display module is embedded in the opening.

As an improvement of the present invention, at least a portion of the doll body corresponding to the display module is semitransparent; and a projected temperature digit of the display module can be seen through or above the semitransparent portion.

As an improvement of the present invention, at least a part of the doll body is configured to present different colors with the change of temperature.

As an improvement of the present invention, the doll body is internally provided with a sounding structure for prompting a user.

As an improvement of the present invention, the sounding structure is a horn or a buzzer.

As an improvement of the present invention, the temperature measurement circuit is provided thereon with a Bluetooth module or an external data interface.

As an improvement of the present invention, the infrared light filter is provided thereon with a condenser.

As an improvement of the present invention, the measurement precision of the infrared thermopile sensing element having a chip structure is ±0.1° C.

As an improvement of the present invention, the battery is a flaky flexible polymer battery.

As an improvement of the present invention, the infrared light filter is designed to be a Fresnel lens.

The present invention integrates the temperature measurement circuit and the doll, not only can satisfy the requirement of providing a playable doll, but also can achieve the advantages of non-contact with human body, quick temperature measurement speed, and high temperature measurement accuracy.

### BRIEF DESCRIPTION OF THE DRAWINGS

FIG. 1 is a structural schematic view according to a first embodiment of the present invention;

FIG. 2 is a perspective structural schematic view of the embodiment as shown in FIG. 1;

FIG. 3 is a structural schematic view according to a second embodiment of the present invention;

FIG. 4 is a perspective structural schematic view of the embodiment as shown in FIG. 3; and

FIG. 5 is a schematic block diagram of the circuit according to the present invention.

### DETAILED DESCRIPTION OF THE PRESENT DISCLOSURE

In the descriptions of the present invention, it should be understood that the azimuth or position relationships indicated by the terms “center”, “up”, “down” “front”, “back”, “left”, “right” and the like are the azimuth or position relationships as shown in the drawings, and are only intended to facilitate the description of the present invention and simplify the description, but not to indicate or imply that the designated devices or elements must have a specific azimuth or are constructed and operated in a specific azimuth. Therefore, the terms cannot be considered to limit the present invention. In addition, the terms “first” and “second” are used for the purpose of description only, but cannot be considered to indicate or imply relative importance.

In the descriptions of the present invention, it should be noted that unless otherwise specified and stated, the terms “mount”, “connect”, and “connection” should be understood in a broad sense, for example, the term “connection” can be a fixed connection, a detachable connection, or an integral connection, can be a mechanical connection, or an electrical connection, and can be a direct connection, an indirect connection via an intermediate medium, or an internal communication between two elements. A person skilled in the art can understand the specific meanings of the above terms in the present invention according to specific circumstances. In addition, in the descriptions of the present invention, unless otherwise stated, the meanings of “multiple” and “a plurality of” are two or more.

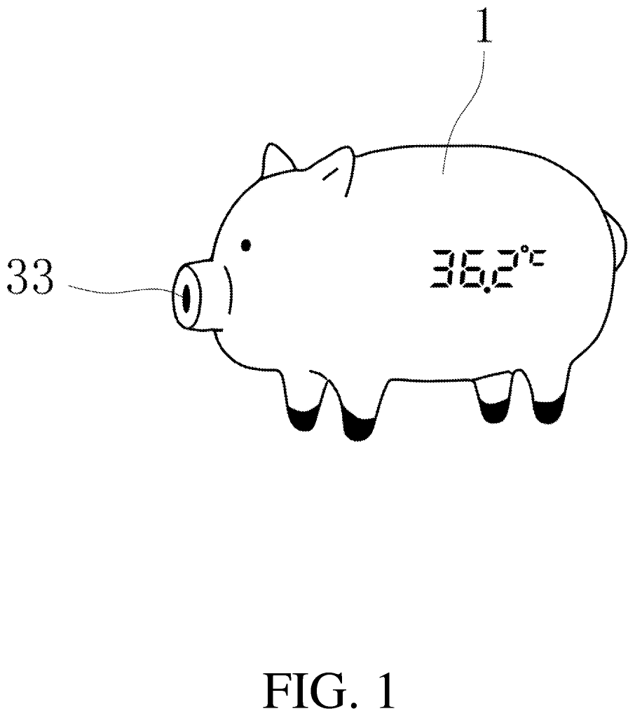

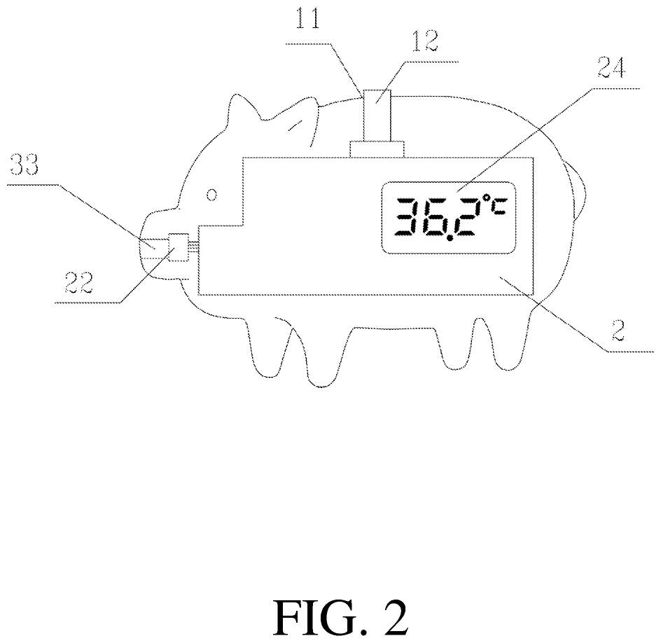

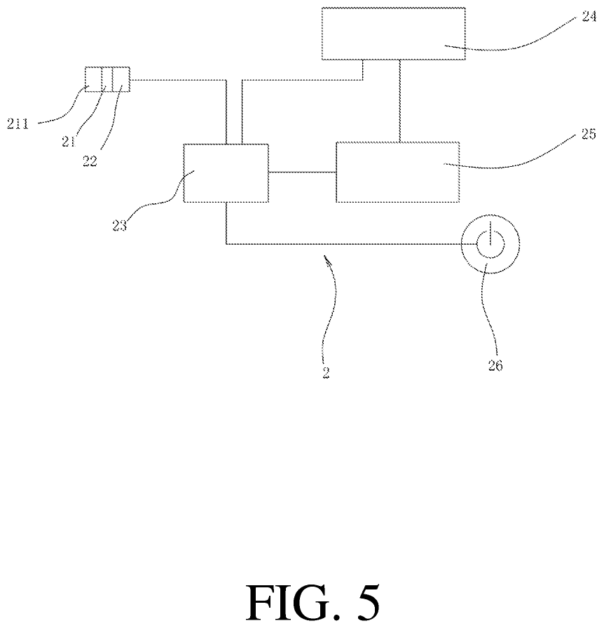

With reference to FIGS. 1, 2 and 5, FIGS. 1, 2 and 5 show a first embodiment of an infrared body temperature measurement doll (the doll in the embodiment is described by taking a boar as an example), comprising a doll body 1 and a temperature measurement circuit 2 disposed in the doll body, wherein the temperature measurement circuit 2 comprises an infrared light filter 21, an infrared thermopile sensing element 22 having a chip structure, an amplification circuit 23, a display module 24, a battery 25, and a power supply switch 26; the infrared light filter 21 is disposed on the infrared thermopile sensing element 22 having a chip structure; the infrared thermopile sensing element 22 having a chip structure, the amplification circuit 23, and the display module 24 are sequentially electrically connected; the battery 25 supplies power to the infrared thermopile sensing element 22 having a chip structure, the amplification circuit 23, and the display module 24; the infrared thermopile sensing element 22 is disposed in an organ of the doll body 1 in communication with the ambient; and the infrared thermopile sensing element 22 senses a human body temperature via a hole 33 on the organ.

Preferably, a button hole 11 is disposed on the doll body 1; and a button 12 of the power supply switch 26 protrudes out of the doll body 1 via the button hole 11.

Preferably, the doll body 1 is made into a key ring or a hanging ornament.

Preferably, the doll body 1 is provided with an opening corresponding to the display module 24; and the display module 24 is embedded in the opening.

Preferably, at least a portion of the doll body 1 corresponding to the display module 24 is semitransparent; and a projected temperature digit of the display module 24 can be seen through or above the semitransparent portion.

Preferably, at least a part of the doll body 1 is configured to present different colors with the change of temperature; alternatively, the whole doll body is configured to present different colors with the change of temperature.

Preferably, the doll body 1 is internally provided with a sounding structure for prompting a user; and the sounding structure can be a horn or a buzzer.

Preferably, the temperature measurement circuit 2 is provided thereon with a Bluetooth module or an external data interface; the doll can exchange information with an intelligent electronic device, such as a mobile phone and the like, via the Bluetooth module or the external data interface, so as to realize monitoring via an APP program or store body temperature data of a measured person for analysis.

Preferably, the infrared light filter is provided thereon with a condenser.

Preferably, the measurement precision of the infrared thermopile sensing element having a chip structure is ±0.1° C.

Preferably, the battery is a flaky flexible polymer battery.

Preferably, the infrared light filter is designed to be a Fresnel lens.

Preferably, in the embodiment, the infrared thermopile sensing element 22 can be RE200B, PIS209, LHI878 and the like. The amplification circuit 23 further amplifies the signal, improves the system stability, and provides the display module 24 with a temperature display signal. The infrared light filter 21 can extend a detection range, and improve the measurement sensitivity.

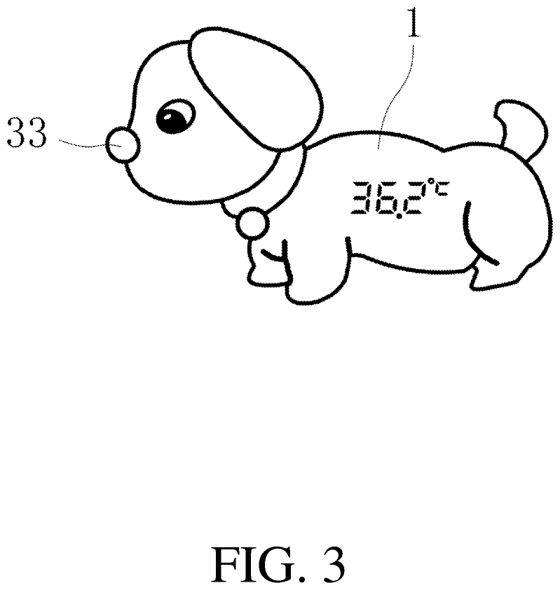

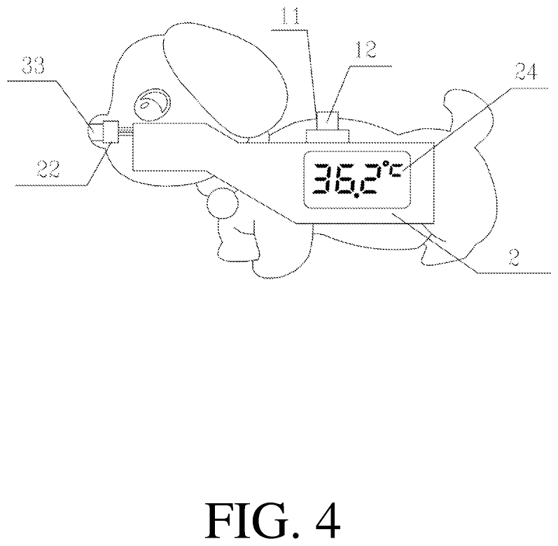

With reference to FIGS. 3, 4 and 5, FIGS. 3, 4 and 5 show a second embodiment of an infrared body temperature measurement doll (the doll in the embodiment is described by taking a dog as an example); compared the embodiment shown in FIGS. 3, 4 and 5 with the embodiment shown in FIGS. 1, 2 and 5, the structure thereof is basically the same, and the difference is that the image of the doll body 1 is a dog.

It is apparent that the image of the doll body 1 can also be a rat, an ox, a tiger, a hare, a dragon, a snake, a horse, a sheep, a monkey, a rooster, a rabbit, a cat, a weasel, a tapir, a dolphin, a seal, a sea lion, an anteater and the like.

The image of the doll body 1 can also be a robot or an animated character.

Certainly, for other animals, the infrared thermopile sensing element 22 can also be placed in other organs such as eye, mouth and the like.

1. An infrared body temperature measurement doll, comprising a doll body (1) and a temperature measurement circuit (2) disposed in the doll body, wherein the temperature measurement circuit (2) comprises an infrared light filter (21), an infrared thermopile sensing element (22) having a chip structure, an amplification circuit (23), a display module (24), a battery (25), and a power supply switch (26); the infrared light filter (21) is disposed on the infrared thermopile sensing element (22) having a chip structure; the infrared thermopile sensing element (22) having a chip structure, the amplification circuit (23), and the display module (24) are sequentially electrically connected; the battery (25) supplies power to the infrared thermopile sensing element (22) having a chip structure, the amplification circuit (23), and the display module (24); the infrared thermopile sensing element (22) is disposed in an organ of the doll body (1) in communication with the ambient; and the infrared thermopile sensing element (22) senses a human body temperature via a hole (33) on the organ.

2. The infrared body temperature measurement doll according to claim 1, wherein a button hole (11) is disposed on the doll body (1); and a button (12) of the power supply switch (26) protrudes out of the doll body (1) via the button hole (11).

3. The infrared body temperature measurement doll according to claim 1, wherein the image of the doll body (1) is a rat, an ox, a tiger, a hare, a dragon, a snake, a horse, a sheep, a monkey, a rooster, a dog, a boar, a rabbit, a cat, a weasel, a tapir, a dolphin, a seal, a sea lion or an anteater.

4. The infrared body temperature measurement doll according to claim 1, wherein the image of the doll body (1) is a robot or an animated character.

5. The infrared body temperature measurement doll according to claim 1, wherein the doll body (1) is made into a key ring or a hanging ornament.

6. The infrared body temperature measurement doll according to claim 1, wherein the doll body (1) is provided with an opening corresponding to the display module (24); and the display module (24) is embedded in the opening.

7. The infrared body temperature measurement doll according to claim 1, wherein at least a portion of the doll body (1) corresponding to the display module (24) is semitransparent; and a projected temperature digit of the display module (24) can be seen through or above the semitransparent portion.

8. The infrared body temperature measurement doll according to claim 1, wherein at least a part of the doll body (1) is configured to present different colors with the change of temperature.

9. The infrared body temperature measurement doll according to claim 1, wherein the doll body (1) is internally provided with a sounding structure for prompting a user.

10. The infrared body temperature measurement doll according to claim 9, wherein the sounding structure is a horn or a buzzer.

11. The infrared body temperature measurement doll according to claim 1, wherein the temperature measurement circuit (2) is provided thereon with a Bluetooth module or an external data interface.

12. The infrared body temperature measurement doll according to claim 2, wherein the image of the doll body (1) is a rat, an ox, a tiger, a hare, a dragon, a snake, a horse, a sheep, a monkey, a rooster, a dog, a boar, a rabbit, a cat, a weasel, a tapir, a dolphin, a seal, a sea lion or an anteater.

13. The infrared body temperature measurement doll according to claim 2, wherein the image of the doll body (1) is a robot or an animated character.

14. The infrared body temperature measurement doll according to claim 2, wherein the doll body (1) is made into a key ring or a hanging ornament.

15. The infrared body temperature measurement doll according to claim 2, wherein the doll body (1) is provided with an opening corresponding to the display module (24); and the display module (24) is embedded in the opening.

16. The infrared body temperature measurement doll according to claim 2, wherein at least a portion of the doll body (1) corresponding to the display module (24) is semitransparent; and a projected temperature digit of the display module (24) can be seen through or above the semitransparent portion.

17. The infrared body temperature measurement doll according to claim 2, wherein at least a part of the doll body (1) is configured to present different colors with the change of temperature.

18. The infrared body temperature measurement doll according to claim 2, wherein the doll body (1) is internally provided with a sounding structure for prompting a user.

19. The infrared body temperature measurement doll according to claim 2, wherein the temperature measurement circuit (2) is provided thereon with a Bluetooth module or an external data interface.
